(19) United States
(12) Patent Application Publication
(10) Pub. No.: US 2026/0010319 A1
(43) Pub. Date: Jan. 8, 2026

(54) DISTRIBUTED STORAGE OPERATING METHOD AND SYSTEM

(71) Applicant: KOREA INSTITUTE OF SCIENCE & TECHNOLOGY INFORMATION, Daejeon (KR)

(72) Inventors: Ki Hyeon KIM, Yuseong-gu (KR); Dong Kyun KIM, Yuseong-gu (KR); Bu Seung CHO, Yuseong-gu (KR)

(73) Assignee: KOREA INSTITUTE OF SCIENCE & TECHNOLOGY INFORMATION, Daejeon (KR)

(21) Appl. No.: 19/257,105

(22) Filed: Jul. 1, 2025

(30) Foreign Application Priority Data
Jul. 3, 2024 (KR) 10-2024-0087455

(51) Int. Cl. G06F 3/06

(52) U.S. Cl. CPC G06F 3/067; G06F 3/0604; G06F 3/0655

(57) ABSTRACT

A distributed storage operating method performed by a Software Defined Network (SDN) controller is provided. The method may comprise receiving a request from a user terminal to transmit specific data from a core storage, determining a first edge storage for providing the specific data based on a location of the user terminal and sending a first request to the first edge storage to transmit the specific data from the first edge storage to the user terminal, when the specific data is stored in the determined first edge storage.

### CROSS-REFERENCE TO RELATED APPLICATION

This application claims priority from Korean Patent Application No. 10-2024-0087455 filed on Jul. 3, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method for operating a distributed storage, and more specifically, to a method and system for operating a distributed storage that can quickly provide data that a user desires to download.

### 2. Description of the Related Art

A content delivery network (CDN) deployment method has conventionally been utilized to enable users to quickly receive requested data through user terminals. A CDN pre-stores content in strategically located data centers to distribute it to users at high speed. Thus, conventionally, a method of maximizing content delivery speed by minimizing the physical distance between a user terminal and a content storage using the CDN has been used.

FIG. 1 illustrates the implementation of a CDN. When an end user 11 sends a Domain Name Server (DNS) request, a local DNS 12 delivers it to a load balancer 13. The load balancer 13 then provides the address of an optimal edge server 14 corresponding to the user's location back to the end user 11 via the local DNS 12.

Next, the end user 11 transmits a HyperText Transfer Protocol (HTTP) request to the edge server 14 at the address provided by the load balancer 13. The edge server 14 receives the data requested by the end user 11 from an origin server 15 through an optimal path by interacting with the load balancer 13 and delivers it to the end user 11. The received data is permanently cached in the edge server 14.

In the above-described CDN implementation method, a local DNS, a load balancer, and a caching storage must be separately provided to handle each user's DNS request, which results in excessive cost.

Therefore, there is a need for a more economical method of delivering edge content is required, and for improving conventional methods of facilitating data transfer by reducing the physical distance between user terminals and data storage servers.

### SUMMARY

One objective of the present disclosure is to provide a method for handling a user's data download request without the need for a DNS request processing procedure.

Another objective of the present disclosure is to provide a method for specifying a closest storage to a user terminal without the need for a DNS request processing procedure.

Yet another objective of the present disclosure is to provide a method for specifying target data to be transmitted to an edge storage that covers a specific region, among data stored in an origin storage.

Still another objective of the present disclosure is to provide a method for transmitting specific data to an edge storage that covers a region with high usage frequency of the specific data based on the importance of the specific data in each of a plurality of regions.

The objectives of the present disclosure are not limited to those mentioned above, and other objectives not explicitly stated will be clearly understood by those skilled in the art based on the following description.

According to some embodiments of the present disclosure, a distributed storage operating method performed by a Software Defined Network (SDN) controller is provided. The method may comprise receiving a request from a user terminal to transmit specific data from a core storage, determining a first edge storage for providing the specific data based on a location of the user terminal and sending a first request to the first edge storage to transmit the specific data from the first edge storage to the user terminal, when the specific data is stored in the determined first edge storage.

In some embodiments, the determining of the first edge storage may comprise determining, as the first edge storage, an edge storage located closest to the location of the user terminal among a plurality of edge storages.

In some embodiments, the method may further comprise sending a second request to the core storage to transmit the specific data from the core storage to the user terminal, when the specific data is not present in the first edge storage.

In some embodiments, the method may further comprise identifying a second edge storage located at a second-closest location to the user terminal, when the specific data is not present in the first edge storage and sending a third request to the second edge storage to transmit the specific data from the second edge storage to the user terminal, when the specific data is stored in the identified second edge storage.

In some embodiments, the method may further comprise calculating an importance score of the specific data and storing the specific data in the first edge storage in response to the calculated importance score being determined to be equal to or greater than a threshold, before the receiving of the request to transmit the specific data.

In some embodiments, the calculating of the importance score of the specific data may comprise calculating the importance score using at least one of a number of downloads of the specific data by a plurality of user terminals located in a region covered by the first edge storage, a total number of downloads of the specific data, a number of downloads of the specific data per unit time, and update status information of the specific data.

According to some embodiments of the present disclosure, a distributed storage operating method performed by a Software Defined Network (SDN) controller is provided. The method may comprise acquiring log information for first data, calculating an importance score for the first data in a first edge storage based on the acquired log information and sending a request to a core storage to transmit the first data stored in the core storage to the first edge storage, when the calculated importance score is equal to or greater than a reference value.

In some embodiments, the log information for the first data may comprise at least one of a number of downloads of the first data by a plurality of user terminals located in a region covered by the first edge storage, a total number of downloads of the first data, a number of downloads of the first data per unit time, and update status information of the first data.

In some embodiments, the update status information of the first data may be information indicating whether an update history exists for the first data within a reference time.

In some embodiments, the sending of the request to transmit the first data stored in the core storage to the first edge storage may comprise sending a request to the first edge storage to delete second data among data stored in the first edge storage whose importance score is below the reference value, when the first edge storage is unable to store the first data due to a lack of storage capacity.

In some embodiments, the sending of the request to transmit the first data stored in the core storage to the first edge storage may comprise sending a request to the core storage to transmit the first data to a second edge storage, which is geographically closest to the first edge storage, when the first edge storage is unable to store the first data.

According to some embodiments of the present disclosure, a distributed storage operating system is provided. The system may comprise at least one processor and a memory storing a computer program executed by the at least one processor. The computer program may include instructions that cause the at least one processor to perform operations of: receiving a request from a user terminal to transmit specific data from a core storage, determining a first edge storage for providing the specific data based on a location of the user terminal and sending a first request to the first edge storage to transmit the specific data from the first edge storage to the user terminal, when the specific data is stored in the determined first edge storage.

In some embodiments, the determining of the first edge storage may comprise determining, as the first edge storage, an edge storage located closest to the location of the user terminal among a plurality of edge storages.

In some embodiments, the computer program may further include instructions that cause the processor to an operation of: sending a second request to the core storage to transmit the specific data from the core storage to the user terminal, when the specific data is not present in the first edge storage.

In some embodiments, the computer program may further include instructions that cause the processor to perform operations of: identifying a second edge storage located at a second-closest location to the user terminal, when the specific data is not present in the first edge storage and sending a third request to the second edge storage to transmit the specific data from the second edge storage to the user terminal, when the specific data is stored in the identified second edge storage.

In some embodiments, the computer program may further include instructions that cause the processor to perform operations of: calculating an importance score of the specific data before the receiving of the request to transmit the specific data and storing the specific data in the first edge storage in response to the calculated importance score being determined to be equal to or greater than a threshold.

According to some embodiments of the present disclosure, a distributed storage operating system is provided. The system may comprise at least one processor and a memory storing a computer program executed by the at least one processor. The computer program may include instructions that cause the processor to perform operations of: acquiring log information for first data, calculating an importance score for the first data in a first edge storage based on the acquired log information and sending a request to a core storage to transmit the first data stored in the core storage to the first edge storage, when the calculated importance score is equal to or greater than a reference value.

In some embodiments, the log information for the first data may include at least one of a number of downloads of the first data by a plurality of user terminals located in a region covered by the first edge storage, a total number of downloads of the first data, a number of downloads of the first data per unit time, and update status information of the first data.

In some embodiments, the sending of the request to transmit the first data stored in the core storage to the first edge storage may comprise sending a request to the core storage to transmit the first data to a second edge storage, which is geographically closest to the first edge storage, when the first edge storage is unable to store the first data.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a diagram illustrating a conventional content delivery network (CDN) operating method, provided to explain the problems of the related art;

FIG. 2 illustrates an exemplary environment in which a distributed storage operating system according to an embodiment of the present disclosure may be applied;

FIG. 3 is a flowchart illustrating a distributed storage operating method according to an embodiment of the present disclosure;

FIG. 4 is a diagram illustrating a step of handling a user's specific data download request, which may be performed in some embodiments;

FIG. 5 is a flowchart illustrating a distributed storage operating method according to another embodiment of the present disclosure;

FIG. 6 is a diagram illustrating a step of transmitting a portion of the data stored in a core storage to an edge storage, which may be performed in some embodiments;

FIG. 7 is a table showing importance scores for respective pieces of data in respective edge storages, which may be referenced in some embodiments; and

FIG. 8 is a block diagram illustrating a hardware configuration of a computing system according to an embodiment of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Before describing various embodiments, the terms used in this specification will first be clarified.

In some embodiments, the term “core storage” may refer to a storage system that stores original data.

In some embodiments, the term “edge storage” may refer to a storage system that is located at a geographic location different from a core storage and stores a portion of the data stored in the core storage.

In some embodiments, the term “edge storage” may refer to a storage system that is different from the core storage and located within a predefined distance from a user terminal. Some embodiments will hereinafter be described with reference to the accompanying drawings.

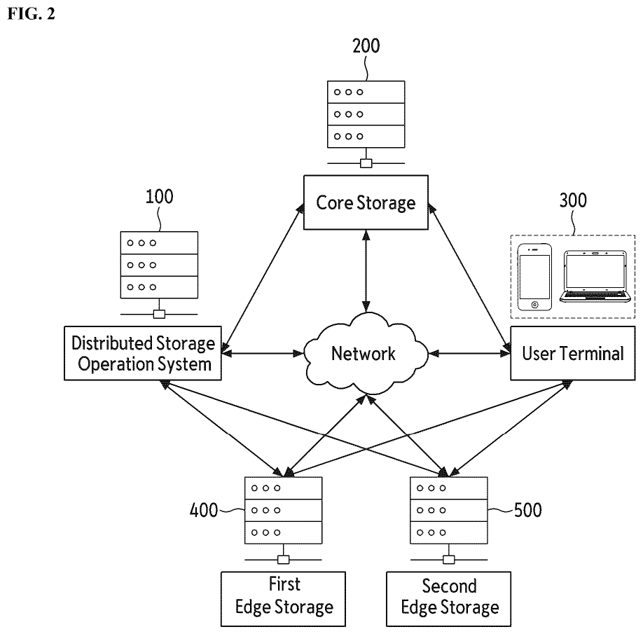

FIG. 2 illustrates an exemplary environment in which a distributed storage operating system 100 according to an embodiment of the present disclosure may be applied.

Referring to FIG. 2, in some embodiments, the distributed storage operating system 100 may include a Software Defined Network (SDN) controller. Here, the SDN controller may be a separate system, or may be implemented in any one of a core storage 200, a first edge storage 400, and a second edge storage 500 illustrated in FIG. 2, but the present disclosure is not limited thereto.

A user terminal 300 may be a notebook computer, desktop computer, laptop computer, smartphone, or tablet, but is not limited thereto and may include any type of device having computing capabilities and a MAC address.

Meanwhile, each component illustrated in FIG. 2 may refer to, but is not limited to, software or hardware, such as a Field Programmable Gate Array (FPGA) or an Application-Specific Integrated Circuit (ASIC), and may be configured to reside in an addressable storage medium or to operate one or more processors. The functions provided within these components may be implemented by more detailed subcomponents, or multiple components may be combined into one component that performs specific functions.

In some embodiments, the distributed storage operating system 100 may communicate with the other components through a network. The network may be implemented as any type of wired or wireless network, such as a Local Area Network (LAN), Wide Area Network (WAN), mobile radio communication network, or Wireless Broadband Internet (WiBro).

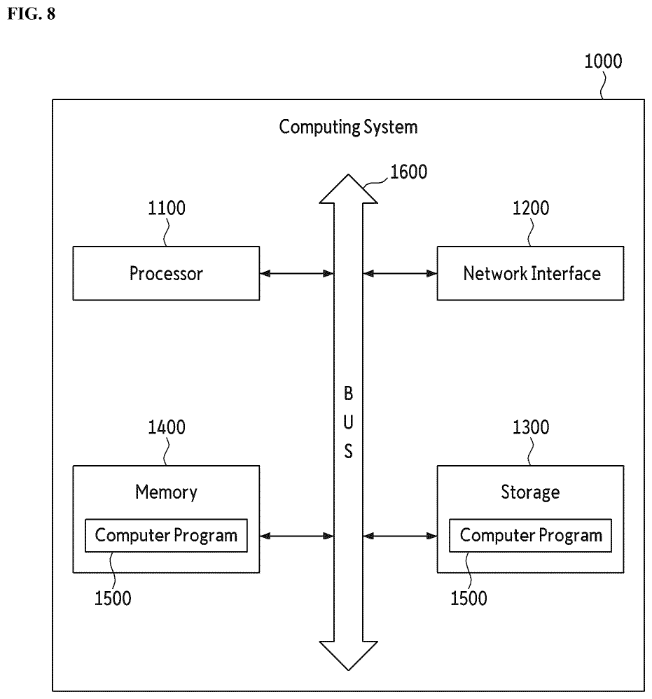

In addition, regarding the configurations of the distributed storage operating system 100 and the user terminal 300, the hardware configuration depicted in FIG. 8 may be referenced. That is, the distributed storage operating system 100 and the user terminal 300 may have a hardware configuration to be described with reference to FIG. 8. Furthermore, the technical idea that can be understood from embodiments to be described below may be incorporated into the distributed storage operating system 100, even if not explicitly mentioned.

Operations that may be performed by each component illustrated in FIG. 2 will hereinafter be described.

The distributed storage operating system 100 may receive a transmission request for specific data in the core storage 200 from the user terminal 300.

The distributed storage operating system 100 may determine an edge storage for providing the specific data, based on the location of the user terminal 300.

In some embodiments, the distributed storage operating system 100 may receive location information of the user terminal 300 from the user terminal 300 and may determine the first edge storage 400, which is located at the closest position to the user terminal 300, as the edge storage for providing the specific data. Here, the location information may include Global Positioning System (GPS) coordinates. Additionally, the location information may include a cell identifier and an access point identifier, and the distributed storage operating system 100 may identify the location of the user terminal 300 by using one or more of the cell identifier and the access point identifier. To this end, the distributed storage operating system 100 may store a location table in which cell identifiers or access point identifiers are mapped to locations.

In one embodiment, the distributed storage operating system 100 may store coverage range information of each edge storage. Here, the coverage range information may include one or more cell identifiers, one or more access point identifiers, and GPS coordinate ranges. In another embodiment, when the specific data is stored in the first edge storage 400 determined as the edge storage for providing the specific data, the distributed storage operating system 100 may send a first request to the first edge storage 400 to transmit the specific data to the user terminal 300.

In some embodiments, if it is determined that the specific data does not exist in the first edge storage 400, the distributed storage operating system 100 may send a second request to the core storage 200 to transmit the specific data to the user terminal 300.

In some embodiments, if it is determined that the specific data does not exist in the first edge storage 400 but exists in the second edge storage 500, which is located at the second-closest position to the user terminal 300, the distributed storage operating system 100 may send a third request to the second edge storage 500 to transmit the specific data to the user terminal 300.

In some embodiments, the distributed storage operating system 100 may determine whether the specific data exists in the first edge storage 400 based on a list of data stored in the first edge storage 400, present in the distributed storage operating system 100.

In some embodiments, the distributed storage operating system 100 may send a query associated with the specific data to the first edge storage 400 and may determine whether the specific data exists in the first edge storage 400 based on information transmitted by the first edge storage 400 in response to the query.

In some embodiments, the distributed storage operating system 100 may acquire log information for first data.

In some embodiments, the log information for the first data may include: the number of downloads of the first data by a plurality of user terminals 300 located in a region covered by the first edge storage 400; the number of downloads of the first data by a plurality of user terminals 300 located in a region covered by the second edge storage 500; the total number of downloads of the first data; the number of downloads of the first data per unit time; and update status information of the first data.

In some embodiments, the distributed storage operating system 100 may calculate an importance score for the first data in the first edge storage 400 based on the acquired log information for the first data.

In some embodiments, the importance score for the first data in the first edge storage 400 may be calculated based on the following information included in the log information for the first data: the number of downloads of the first data by the user terminals 300 located in the region covered by the first edge storage 400; the total number of downloads of the first data; the number of downloads of the first data per unit time; and the update status information of the first data. This will be described later in further detail.

The distributed storage operating system 100 may send a request to the core storage 200 to transmit the first data stored in the core storage 200 to the first edge storage 400 if the importance score for the first data in the first edge storage 400 is equal to or higher than a reference value.

In some embodiments, if the first data cannot be stored in the first edge storage 400 due to a lack of storage capacity, the distributed storage operating system 100 may send a request to the first edge storage 400 to delete second data whose importance score is lower than the reference value among the data present in the first edge storage 400.

Thus far, the configuration and operation of the distributed storage operating system 100 and the exemplary environment to which the distributed storage operating system 100 is applied have been described with reference to FIG. 2. The distributed storage operating system 100 and the core storage 200 may be understood as operating according to a server-client model. However, in some embodiments, the distributed storage operating system 100 may be configured in a client stand-alone manner without a server. In this case, operations performed by the distributed storage operating system 100 may be understood as being performed by the core storage 200.

In some embodiments, at least one of the core storage 200, the first edge storage 400, and the second edge storage 500 may be a heterogeneous storage system different from the remaining storage systems. In one example, the core storage 200 may be a storage system based on the Ceph architecture, whereas the first edge storage 400 and the second edge storage 500 may be storage systems based on the MiniIO architecture.

In another example, the core storage 200 may be a storage system based on the Rustre architecture, whereas the first edge storage 400 and the second edge storage 500 may be storage systems based on the Ceph architecture.

In yet another example, the core storage 200 may be a storage system based on the Ceph architecture, the first edge storage 400 may be a storage system based on the MiniIO architecture, and the second edge storage 500 may be a storage system based on the Rustre architecture.

In some embodiments, when each of the storage systems illustrated in FIG. 2 is a heterogeneous storage system, the distributed storage operating system 100 may interact with each of the core storage 200, the first edge storage 400, and the second edge storage 500 using a different application programming interface (API).

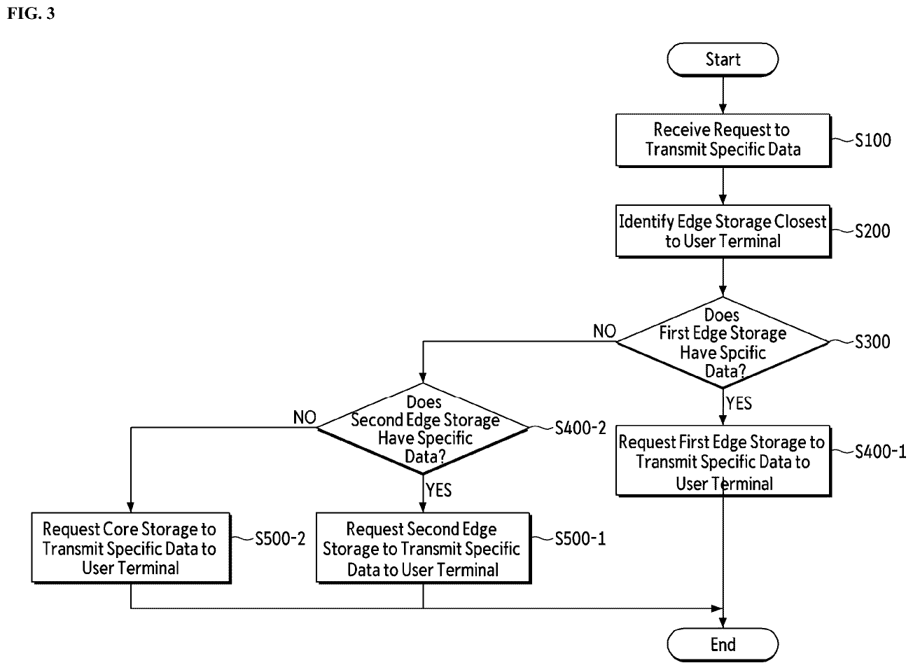

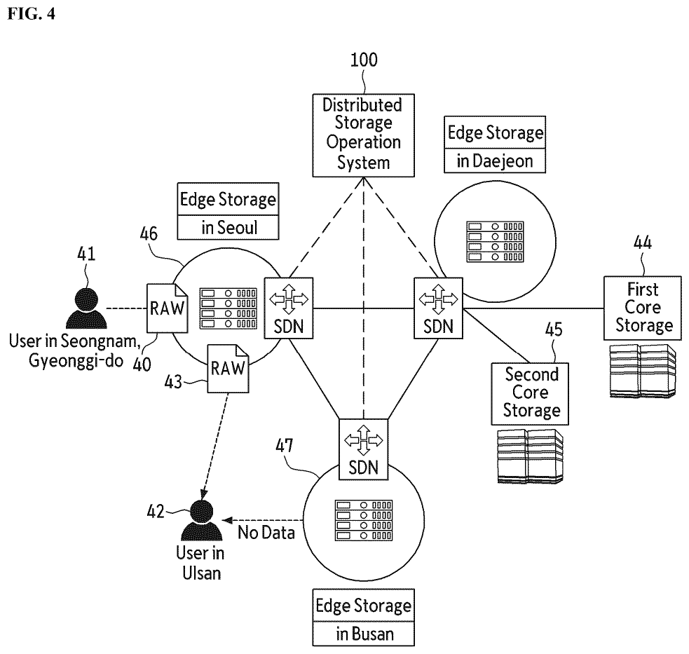

A distributed storage operating method according to an embodiment of the present disclosure will hereinafter be described with reference to FIGS. 3 and 4. The distributed storage operating method according to an embodiment of the present disclosure may be performed by one or more computing systems. In addition, some steps of the distributed storage operating method according to an embodiment of the present disclosure may be performed by a first computing device, and the remaining operations or steps may be performed by a second computing device. For example, some steps of the distributed storage operating method according to an embodiment of the present disclosure may be performed by an on-premise physical server, and the remaining operations or steps may be performed by a cloud compute instance. Also, for example, some steps may be performed by the distributed storage operating system 100, and the remaining operations or steps may be performed by the core storage 200. In the following description, when a subject that performs each operation or step is omitted, it may be understood that the corresponding operation or step is performed by a computing system.

Referring to FIG. 3, in step S100, the distributed storage operating system 100 may receive a request for transmission of specific data stored in the core storage 200 from the user terminal 300.

In some embodiments related to step S100, the distributed storage operating system 100 may receive a request for transmission of specific data, targeting either a first edge storage 400 or a second edge storage 500, from the user terminal 300.

In other embodiments related to step S100, the distributed storage operating system 100 may receive a request for transmission of specific data, targeting the distributed storage operating system 100, from the user terminal 300.

In step S200, the distributed storage operating system 100 may determine an edge storage for providing the specific data based on the location of the user terminal 300. In some embodiments, the distributed storage operating system 100 may identify the location of a user terminal 300 and determine the closest edge storage to the identified location as the edge storage for providing the specific data. In one example, referring to FIG. 4, the distributed storage operating system 100 may determine an edge storage 47 in Busan, which is located closest to a user terminal 300 of a user 42 in Ulsan, as the edge storage for providing first data 43 requested by the user terminal 300 of the user 42.

In another example, referring to FIG. 4, the distributed storage operating system 100 may determine a second core storage 45, which is located farthest from a user terminal 300 of a user 41 in Seongnam, Gyeonggi-do, as the storage system for providing second data 40 requested by the user terminal 300 of the user 41 in Seongnam.

In step S300, the distributed storage operating system 100 may determine whether the specific data exists in a first edge storage 400 determined as the edge storage for providing the specific data in step S200. In some embodiments, the distributed storage operating system 100 may determine whether the specific data exists in the first edge storage 400 based on a list of data currently stored in the first edge storage 400.

In step S400-1, when it is determined that the specific data is stored in the first edge storage 400, the distributed storage operating system 100 may send a first request to the first edge storage 400 to transmit the specific data from the first edge storage 400 to the user terminal 300. In response to the first request being sent to the first edge storage 400, the specific data stored in the first edge storage 400 may be transmitted to the user terminal 300.

In one example, referring to FIG. 4, when the second data 40 corresponding to a data transmission request sent by the user terminal 300 of the user 41 in Seongnam exists in an edge storage 46 in Seoul, which is located geographically closest to the user terminal 300 of the user 41, the distributed storage operating system 100 may send a request to the edge storage 46 in Seoul to transmit the second data 40 to the user terminal 300 of the user 41 in Seongnam. In this case, the second data 40 stored in the edge storage 46 in Seoul may be transmitted to the user terminal 300 of the user 41 in Seongnam.

In step S400-2, when the specific data does not exist in the first edge storage 400 located closest to the user terminal 300, the distributed storage operating system 100 may determine whether the specific data exists in the second edge storage 500 located at the second-closest position to the user terminal 300. In some embodiments, the distributed storage operating system 100 may determine whether the specific data exists in the second edge storage 500 based on a list of data currently stored in the second edge storage 500.

In step S500-1, when the specific data exists in the second edge storage 500, the distributed storage operating system 100 may send a third request to the second edge storage 500 to transmit the specific data from the second edge storage 500 to the user terminal 300. In response to the third request being sent to the second edge storage 500, the specific data stored in the second edge storage 500 may be transmitted to the user terminal 300.

In step S500-2, when it is determined that neither the first edge storage 400 nor the second edge storage 500 stores the specific data, the distributed storage operating system 100 may send a second request to the core storage 200 to transmit the specific data from the core storage 200 to the user terminal 300. In response to the second request being sent to the core storage 200, the specific data stored in the core storage 200 may be transmitted to the user terminal 300.

In one example, referring to FIG. 4, when it is determined that the first data 43 requested by the user terminal 300 of the user 42 in Ulsan does not exist in the edge storage 47 in Busan, which is closest to the user terminal 300 of the user 42, but exists in the edge storage 46 in Seoul, which is the second-closest storage system to the user terminal 300 of the user 42, the distributed storage operating system 100 may send a request to the edge storage 46 in Seoul to transmit the first data 43 to the user terminal 300 of the user 42 in Ulsan.

In another example, when it is determined that the first data 43 requested by the user terminal 300 of the user 42 in Ulsan does not exist in the edge storage 47 in Busan, which is closest to the user terminal 300 of the user 42, nor in the edge storage 46 in Seoul, the distributed storage operating system 100 may send a request to a first core storage 44 to transmit the first data 43 from the first core storage 44 to the user terminal 300 of the user 42 in Ulsan. Here, the first core storage 44 may be a core storage located closer than the second core storage 45 to the user terminal 300 of the user 42.

In some embodiments related to steps S400-2 and S500-2, referring to FIG. 4, when it is determined that none of the edge storage 47 in Busan, the edge storage 46 in Seoul, and the first core storage 44 store the first data 43 requested by the user terminal 300 of the user 42 in Ulsan, the distributed storage operating system 100 may send a request to a second core storage 45 to transmit the first data 43 from the second core storage 45 to the user terminal 300 of the user 42 in Ulsan. In this case, when it is determined that the second core storage 45 also does not store the first data 43, the distributed storage operating system 100 may transmit information indicating the absence of the first data 43 to the user terminal 300 of the user 42 in Ulsan.

In this manner, an edge storage capable of transmitting data at the fastest speed based on the location of the user terminal 300 may be determined, and specific data requested for download may be provided to the user terminal 300 at high speed through the determined edge storage. In addition, data may be quickly transmitted to the user terminal 300 without the need for DNS request processing.

Thus far, the distributed storage operating method according to an embodiment of the present disclosure has been described with reference to FIGS. 3 and 4. However, it is to be noted that the embodiments described above are illustrative in all respects and should not be construed as limiting.

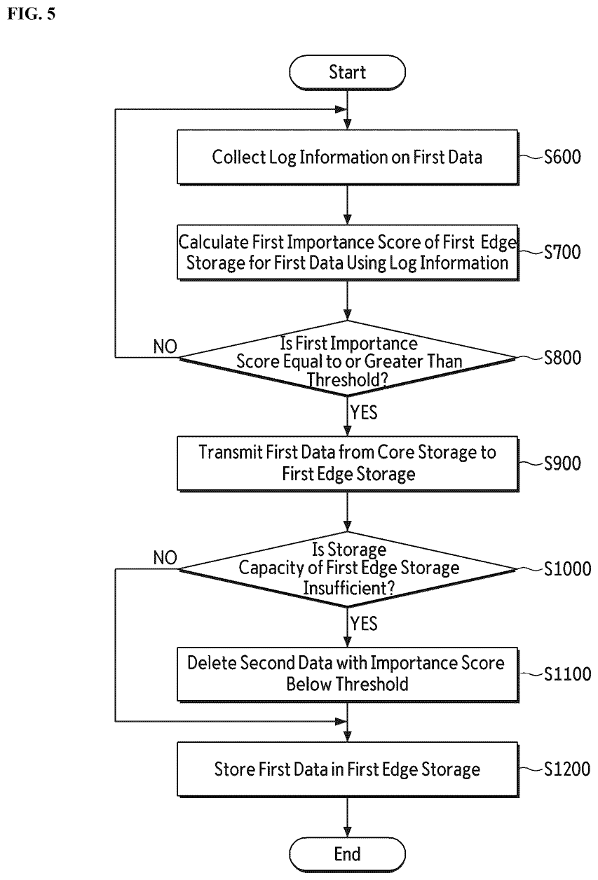

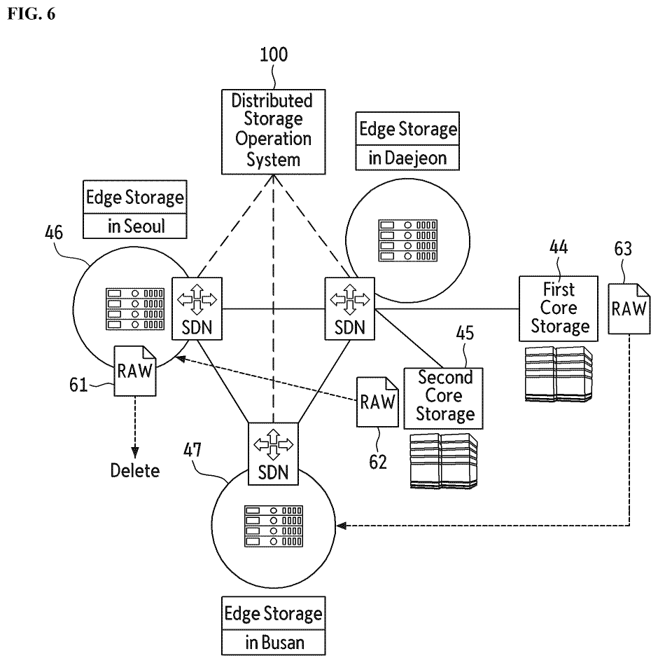

A distributed storage operating method according to another embodiment of the present disclosure will hereinafter be described with reference to FIGS. 5 and 6. The distributed storage operating method according to another embodiment of the present disclosure may be performed by one or more computing systems. In addition, some steps of the distributed storage operating method according to another embodiment of the present disclosure may be performed by a first computing device, and the remaining steps may be performed by a second computing device. For example, some steps of the distributed storage operating method according to another embodiment of the present disclosure may be performed by an on-premise physical server, and the remaining operations or steps may be performed by a cloud compute instance. Also, for example, some steps may be performed by the distributed storage operating system 100, and the remaining operations or steps may be performed by the core storage 200. In the following description, when a subject that performs each operation or step is omitted, it may be understood that the corresponding operation or step is performed by a computing system.

In step S600 illustrated in FIG. 5, the distributed storage operating system 100 may acquire log information for first data.

In some embodiments related to step S600, the log information for the first data may include at least one of: the number of downloads of the first data by a plurality of user terminals 300 located in a region covered by a specific edge storage; the total number of downloads of the first data; the number of downloads of the first data per unit time; and update status information of the first data.

In one example, the number of downloads of the first data per unit time may refer to the number of requests received from a plurality of user terminals 300 within the last 30 days for transmission of the first data.

In another example, the update status information of the first data may refer to whether an update history exists for the first data within the last 30 days.

In step S700, the distributed storage operating system 100 may calculate a first importance score for the first data in the first edge storage 400 based on the log information for the first data.

For example, referring to FIG. 6, the distributed storage operating system 100 may calculate an importance score for third data 62 in the edge storage 46 in Seoul based on the number of downloads of the third data 62 by a plurality of user terminals 300 located in the region covered by the edge storage 46 in Seoul, the total number of downloads of the third data 62, the number of downloads of the third data 62 per unit time, and update status information of the third data 62.

In some embodiments, the distributed storage operating system 100 may calculate the importance score for the third data 62 in the edge storage 46 in Seoul according to the following formula:

$$\frac{( α * 50 ) + ( β * 35 ) + ( γ * 15 ) + ( δ * 5 )}{100}$$

where α denotes the number of downloads of the third data 62 by the plurality of user terminals 300 located in the region covered by the edge storage 46 in Seoul, β denotes the total number of downloads of the third data 62, γ denotes the number of downloads of the third data 62 per unit time, and δ is a Boolean value representing the update status of the third data 62.

It will be understood by those skilled in the art that the weight values multiplied by each variable in the above formula are merely exemplary and may be structurally modified as needed.

In step S800, the distributed storage operating system 100 may determine whether the first importance score for the first data in the first edge storage 400 is equal to or greater than a reference value.

In step S900, if the first importance score is equal to or greater than the reference value, the distributed storage operating system 100 may send a request to the core storage 200 to transmit the first data stored in the core storage 200 to the first edge storage 400.

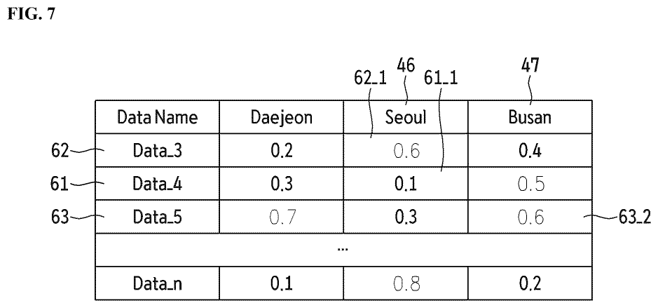

In some embodiments related to step S900, referring to FIGS. 6 and 7, when an importance score 63-2 for fifth data 63 corresponding to the edge storage 47 in Busan is equal to or greater than the reference value, the distributed storage operating system 100 may send a request to the first core storage 44, which stores the fifth data 63, to transmit the fifth data 63 to the edge storage 47 in Busan.

In some embodiments related to step S900, referring to FIGS. 6 and 7, when an importance score 62-1 for third data 62 in the edge storage 46 in Seoul is equal to or greater than the reference value, the distributed storage operating system 100 may send a request to the second core storage 45, which includes the third data 62, to transmit the third data 62 to the edge storage 46 in Seoul.

In step S1000, the distributed storage operating system 100 may determine whether the first edge storage 400 is able to store the first data, based on remaining storage capacity information of the first edge storage 400.

In some embodiments related to step S1000, the distributed storage operating system 100 may be a system that receives and stores information on the remaining storage capacity of each of the core storage 200, the first edge storage 400, and the second edge storage 500 from the corresponding storage at fixed time intervals. In such embodiments, the distributed storage operating system 100 may determine, based on previously stored remaining storage capacity information of the first edge storage 400, whether space for storing the first data exists in the first edge storage 400.

In some embodiments related to step S1000, the distributed storage operating system 100 may determine whether the first edge storage 400 is able to store the first data by receiving information from the first edge storage 400 or the core storage 200 indicating that no storage space for storing the first data exists in the first edge storage 400.

In step S1100, when it is determined that the first edge storage 400 does not have storage space to store the first data, the distributed storage operating system 100 may send a request to the first edge storage 400 to delete second data among the data stored in the first edge storage 400 whose importance score is below the reference value. As a result, the second data with an importance score below the reference value may be deleted from the first edge storage 400, thereby securing storage space for the first data. Therefore, the reference value may be determined based on the importance score of the first data. That is, the reference value may not be fixed statically but may be dynamically determined based on the importance score of the first data to be transmitted. In one example, when the importance score of the first data is “first score,” the distributed storage operating system 100 may determine the reference value as the first score, in which case, data with an importance score lower than the first score may be deleted from the first edge storage 400. In another example, when the importance score of the first data is “first score,” the distributed storage operating system 100 may determine a “second score,” which is lower than the first score by a predefined value, as the reference value, in which case, data with an importance score lower than the second score may be deleted from the first edge storage 400.

For example, referring to FIGS. 6 and 7, when there is no space in the edge storage 46 in Seoul to store third data 62 transmitted from the second core storage 45, the distributed storage operating system 100 may send a request to the edge storage 46 in Seoul to delete fourth data 61 among the data stored in the edge storage 46 in Seoul, whose importance score is below the reference value.

In response to receipt of the request to delete the fourth data 61, the edge storage 46 in Seoul may perform an operation to delete the fourth data 61.

Meanwhile, when there is no space in the edge storage 46 in Seoul to store third data 62 transmitted from the second core storage 45, the distributed storage operating system 100 may send a request to the second core storage 45 to transmit the third data 62 to the edge storage 47 in Busan, which is geographically closest to the edge storage 46 in Seoul.

In step S1200, the distributed storage operating system 100 may send a request to the core storage 200 to transmit the first data to the first edge storage 400 that has secured storage space for storing the first data by deleting the second data.

According to this embodiment, specific data that is expected to be frequently downloaded by users located in a specific region may be predicted based on an importance score and pre-stored in an edge storage. Thus, the cache hit ratio of the edge storage may be improved. In addition, by deleting data with an importance score below the reference value from the edge storage, storage space in the edge storage, which generally has a smaller storage capacity than the core storage, may be efficiently managed.

FIG. 8 is a hardware configuration view of an exemplary computing system 1000. Referring to FIG. 8, the computing system 1000 may include at least one processor 1100, a system bus 1600, a communication interface 1200, a memory 1400, which loads a computer program 1500 executed by the processor 1100, and a storage 1300, which stores the computer program 1500.

The processor 1100 may control the overall operations of the components of the computing system 1000. The processor 1100 may perform computations for at least one application or program for executing operations/methods according to some embodiments of the present disclosure. The memory 1400 may store various data, commands, and/or information. The memory 1400 may load the computer program 1500 from the storage 1300 to execute the operations/methods according to some embodiments of the present disclosure. The memory 1400 may be implemented as a volatile memory such as a random access memory (RAM), but the present disclosure is not limited thereto. The bus 1600 may provide communication functionally among the components of the computing system 1000. The communication interface 1200 may support both wired and wireless Internet communication for the computing system 1000. The storage may temporarily store at least one computer program 1500. The computer program 1500 may include one or more instructions that, upon being loaded into the memory 1400, direct the processor 1100 to perform the operations/methods according to some embodiments of the present disclosure. In other words, by executing the loaded instructions, the processor 1100 may perform the operations/methods according to some embodiments of the present disclosure.

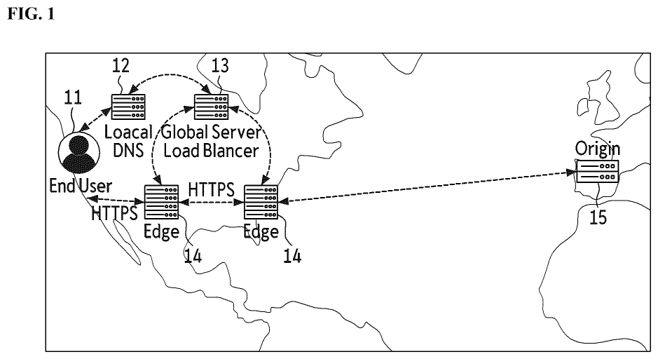

In one example, a computing system 1000 in FIG. 8 may be the distributed storage operating system 100 described with reference to FIG. 1.

In another example, the computing system 1000 in FIG. 8 may be the core storage 200 described with reference to FIG. 1.

In yet another example, the computing system 1000 in FIG. 8 may be the user terminal 300 described with reference to FIG. 1.

the computing system 1000 may refer to a virtual machine implemented based on cloud technology. For example, the computing system 1000 may be a virtual machine operating on one or more physical servers within a server farm. In this example, at least some of the components of the computing system 1000, i.e., the processor 1100, the memory 1400, and the storage 1300, may be implemented as virtual hardware, and the communication interface 1200 may be implemented as a virtual networking element such as a virtual switch.

In some embodiments, a computer program 1500 may include instructions that cause a processor 1100 to perform the operations of: receiving a request from a user terminal to transmit specific data from a core storage; receiving GPS coordinates of the user terminal; determining a first edge storage for providing the specific data based on the location of the user terminal; determining a first edge storage corresponding to the location of the user terminal as the first edge storage for providing the specific data, based on location coverage information of each edge storage, previously stored in a memory 1400 or storage 1300; and when the specific data is stored in the determined first edge storage, sending a first request to the first edge storage to transmit the specific data from the first edge storage to the user terminal.

In some embodiments, the computer program 1500 may include instructions that cause the processor 1100 to perform the operations of: receiving a request from the distributed storage operating system 100 to transmit specific data to the user terminal 300; and transmitting some of previously stored data to a specific edge storage.

In some embodiments, the computer program 1500 may include instructions that cause the processor 1100 to perform the operations of: sending a request to a specific computing system for transmission of specific data; and sending information on the location of the computing system 1000 to a specific computing system.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above are not restrictive but illustrative in all respects.

What is claimed is:

1. A distributed storage operating method performed by a Software Defined Network (SDN) controller, comprising:
receiving a request from a user terminal to transmit specific data from a core storage;
determining a first edge storage for providing the specific data based on a location of the user terminal; and
sending a first request to the first edge storage to transmit the specific data from the first edge storage to the user terminal, when the specific data is stored in the determined first edge storage.

2. The distributed storage operating method of claim 1, wherein the determining of the first edge storage comprises: determining, as the first edge storage, an edge storage located closest to the location of the user terminal among a plurality of edge storages.

3. The distributed storage operating method of claim 1, further comprising:
sending a second request to the core storage to transmit the specific data from the core storage to the user terminal, when the specific data is not present in the first edge storage.

4. The distributed storage operating method of claim 1, further comprising:
identifying a second edge storage located at a second-closest location to the user terminal, when the specific data is not present in the first edge storage; and
sending a third request to the second edge storage to transmit the specific data from the second edge storage to the user terminal, when the specific data is stored in the identified second edge storage.

5. The distributed storage operating method of claim 1, further comprising:
before the receiving of the request to transmit the specific data, calculating an importance score of the specific data; and
storing the specific data in the first edge storage in response to the calculated importance score being determined to be equal to or greater than a threshold.

6. The distributed storage operating method of claim 5, wherein the calculating of the importance score of the specific data comprises: calculating the importance score using at least one of a number of downloads of the specific data by a plurality of user terminals located in a region covered by the first edge storage, a total number of downloads of the specific data, a number of downloads of the specific data per unit time, and update status information of the specific data.

7. A distributed storage operating method performed by a Software Defined Network (SDN) controller, the distributed storage operating method comprising:
acquiring log information for first data;
calculating an importance score for the first data in a first edge storage based on the acquired log information; and
sending a request to a core storage to transmit the first data stored in the core storage to the first edge storage, when the calculated importance score is equal to or greater than a reference value.

8. The distributed storage operating method of claim 7, wherein the log information for the first data comprises at least one of a number of downloads of the first data by a plurality of user terminals located in a region covered by the first edge storage, a total number of downloads of the first data, a number of downloads of the first data per unit time, and update status information of the first data.

9. The distributed storage operating method of claim 8, wherein the update status information of the first data is information indicating whether an update history exists for the first data within a reference time.

10. The distributed storage operating method of claim 7, wherein the sending of the request to transmit the first data stored in the core storage to the first edge storage comprises: sending a request to the first edge storage to delete second data among data stored in the first edge storage whose importance score is below the reference value, when the first edge storage is unable to store the first data due to a lack of storage capacity.

11. The distributed storage operating method of claim 7, wherein the sending of the request to transmit the first data stored in the core storage to the first edge storage comprises: sending a request to the core storage to transmit the first data to a second edge storage, which is geographically closest to the first edge storage, when the first edge storage is unable to store the first data.

12. A distributed storage operating system comprising:
at least one processor; and
a memory storing a computer program executed by the at least one processor,
wherein the computer program includes instructions that cause the at least one processor to perform operations of: receiving a request from a user terminal to transmit specific data from a core storage; determining a first edge storage for providing the specific data based on a location of the user terminal; and sending a first request to the first edge storage to transmit the specific data from the first edge storage to the user terminal, when the specific data is stored in the determined first edge storage.

13. The distributed storage operating system of claim 12, wherein the determining of the first edge storage comprises: determining, as the first edge storage, an edge storage located closest to the location of the user terminal among a plurality of edge storages.

14. The distributed storage operating system of claim 12, wherein the computer program further includes instructions that cause the processor to an operation of: sending a second request to the core storage to transmit the specific data from the core storage to the user terminal, when the specific data is not present in the first edge storage.

15. The distributed storage operating system of claim 12, wherein the computer program further includes instructions that cause the processor to perform operations of: identifying a second edge storage located at a second-closest location to the user terminal, when the specific data is not present in the first edge storage; and sending a third request to the second edge storage to transmit the specific data from the second edge storage to the user terminal, when the specific data is stored in the identified second edge storage.

16. The distributed storage operating system of claim 12, wherein the computer program further includes instructions that cause the processor to perform operations of: calculating an importance score of the specific data before the receiving of the request to transmit the specific data; and storing the specific data in the first edge storage in response to the calculated importance score being determined to be equal to or greater than a threshold.

17. A distributed storage operating system comprising:
at least one processor; and
a memory storing a computer program executed by the at least one processor,
wherein the computer program includes instructions that cause the processor to perform operations of: acquiring log information for first data; calculating an importance score for the first data in a first edge storage based on the acquired log information; and sending a request to a core storage to transmit the first data stored in the core storage to the first edge storage, when the calculated importance score is equal to or greater than a reference value.

18. The distributed storage operating system of claim 17, wherein the log information for the first data includes at least one of a number of downloads of the first data by a plurality of user terminals located in a region covered by the first edge storage, a total number of downloads of the first data, a number of downloads of the first data per unit time, and update status information of the first data.

19. The distributed storage operating system of claim 17, wherein the sending of the request to transmit the first data stored in the core storage to the first edge storage comprises: sending a request to the first edge storage to delete second data among data stored in the first edge storage whose importance score is below the reference value, when the first edge storage is unable to store the first data due to a lack of storage capacity.

20. The distributed storage operating system of claim 17, wherein the sending of the request to transmit the first data stored in the core storage to the first edge storage comprises: sending a request to the core storage to transmit the first data to a second edge storage, which is geographically closest to the first edge storage, when the first edge storage is unable to store the first data.
